(19) United States
(12) Patent Application Publication
(10) Pub. No.: US 2003/0162044 A1
(43) Pub. Date: Aug. 28, 2003

(54) Recyclable light-shadowing and moisture-proof paper

(76) Inventors: Kinya Tamura, Tokyo (JP); Jiro Yoshimura, Tokyo (JP); Mitsuyuki Watanabe, Tokyo (JP); Takanori Otsuhata, Tokyo (JP); Ikuko Seki, Tokyo (JP)

Correspondence Address: NIXON & VANDERHYE, PC, 1100 N GLEBE ROAD, 8TH FLOOR, ARLINGTON, VA, 22201-4714, US

(21) Appl. No.: 10/240,191

(22) PCT Filed: Mar. 27, 2001
(86) PCT No.: PCT/JP01/02472

(30) Foreign Application Priority Data
Mar. 31, 2000 (JP) 2000-98816
Mar. 22, 2001 (JP) 2001-82775

(51) Int. Cl. B32B 3/00

(52) U.S. Cl. 428/484.1

(57) ABSTRACT

Recyclable light proof and moisture proof papers with excellent moisture proofness and light proofness and especially with excellent repulpability during waste paper recovery are provided, which have a single repulpable and recyclable light proof and moisture proof layer on at least one side of a base paper using neither aluminium foil nor an aluminium deposited film, wherein said light proof and moisture proof layer contains 3-70 parts by weight (solids) of a light proof agent and 1-10 parts by weight (solids) of a wax per 100 parts by weight (solids) of a synthetic resin having a gel fraction of 90% or more.

### FIELD OF THE INVENTION

The present invention relates to light proof and moisture proof papers for use as packing papers for photosensitive materials, heat-sensitive recording papers, photographic printing papers or the like, which have excellent moisture proofness and light proofness, and which especially have excellent recyclability so that they are readily repulpable when they are recovered and recycled as waste paper.

### PRIOR ART

Conventional moisture proof papers with light proofness include a base paper laminated with an aluminium foil and a polyolefin resin, a base paper laminated with a polyolefin resin containing carbon black, a black base paper containing carbon black and laminated with a polyolefin resin, etc. However, all of them are extremely hard to repulp when they are recovered and recycled as waste papers and thus can not be recycled and must be incinerated or disposed of in landfills as industrial waste.

A paper with excellent light proofness, moisture proofness and recyclability as a waste paper material is described in JPA 111697/97, comprising a light proof layer containing a light proof agent based on graphite, an organic pigment and a white pigment and a moisture proof layer based on a repulpable acrylic resin provided on a base paper. However, the moisture proof paper having a light proof layer obtained by this method has a structure comprising at least two layers, ie, a moisture proof layer and a light proof layer provided on a base paper so that it was not sufficiently of commercial utility because it had many process constraints such as the number of coating members (coating heads) of the coater or drying equipments and conditions for controlling drying failure such as blister during deposition of the second and subsequent layers, though this moisture proof paper can be recycled in existing paper recycling equipment without any need for a decarbonization process, because neither aluminium nor carbon black is used in the light proof layer.

It is an object of the present invention to provide a light proof and moisture proof paper having excellent light proofness and moisture proofness even under severe conditions such as high humidity as well as excellent recyclability during waste paper recovery while improving productivity and decreasing process constraints.

### SUMMARY OF THE INVENTION

We accomplished the present invention on the basis of the finding that the above problems can be solved by providing a single repulpable and recyclable light proof and moisture proof layer on one side of a base paper using neither aluminium foil nor an aluminium deposited film unlike the prior art conferring light proofness and moisture proofness by a plurality of layers.

### THE MOST PREFERRED EMBODIMENTS OF THE INVENTION

The present invention provides light proof and moisture proof papers with excellent recyclability, and having a light proof and moisture proof layer which is repulpable with water or warm water and has sufficient moisture proofness and light proofness at a coating weight equal to or less than the total coating weight of a light proof layer and a moisture proof layer in conventional two-layer papers though it consists of a single layer, wherein said light proof and moisture proof layer keeps moisture proofness and light proofness without dissolving even under severe conditions such as high humidity, and is readily repulpable during waste paper recovery.

In order to obtain good repulpability during waste paper recovery, the synthetic resin used in the present invention preferably has a gel fraction in the range of 90-100%. So far as the gel fraction is 90% or more, the light proof and moisture proof layer has a low elongation so that it has good repulpability, ie, it is easy to finely separate and disperse under the shearing force applied during repulping. As the gel fraction is increased to decrease the elongation of the resin, good repulpability is obtained independently of the Tg (glass transition temperature) of the resin. If the gel fraction is less than 90%, however, the light proof and moisture proof layer is flexible and has high elongation during repulping so that this elongation resists the shearing force applied during repulping, whereby it is hard to finely separate and disperse and thus hard to repulp. The gel fraction (crosslinking degree in particles) of the synthetic resin used in the present invention can be controlled by selecting crosslinkers such as divinylbenzene, diallyl phthalate, allyl methacrylate, ethylene glycol dimethacrylate and other reaction aids or reaction conditions used in the preparation thereof.

In addition to good repulpability as described above, the synthetic resin used in the present invention should have high moisture proofness imparted by adding a wax. Resins exhibiting such a performance include styrene acrylic resins and styrene butadiene resins, specifically, copolymer resins of styrene and styrene derivatives, butadiene and butadiene derivatives, (meth)acrylic acid and acrylate esters such as methyl acrylate, ethyl acrylate, butyl acrylate and 2-ethylhexyl acrylate or methacrylate esters such as methyl methacrylate, ethyl methacrylate and butyl methacrylate, which may be used alone or in combination.

Film-forming aids having the function of improving film formation without unfavorably affecting the quality of repulpability or the like such as ethylene glycol monomethyl ether, ethylene glycol monoethyl ether, ethylene glycol monobutyl ether, 2,2,4-trimethylpentadiol-1,3-monoisobutyrate, diethylene glycol mono-tert-butyl ether, ethylene glycol monoethyl ether acetate, ethylene glycol monoisobutyl ether acetate, toluol, xylol and terpene, or plasticizers such as DPO and DBP can be used. Especially, these are preferably used in the range of 1-10 parts by weight per 100 parts by weight of solids of the synthetic resin. The use of these film-forming aids or plasticizers can reduce the amount of the wax to be added and benefit to decrease friction coefficient (improve slidability), which readily confers characteristics as packing papers and contributes to good recyclability while rolls of the paper machine are less contaminated during recycling as waste paper materials. However, aqueous binders such as polyvinyl alcohol or starch are not preferred because they may cause the light proof and moisture proof layer to dissolve at high humidity.

The Tg of the synthetic resin is preferably in the range of 0-70° C. considering that film-forming properties are deteriorated if it is too high while the resin becomes viscous to invite blocking or the like if it is too low.

The light proof and moisture proof layer preferably contains 3-70 parts by weight of a light proof agent and 1-10 parts by weight (solids) of a wax per 100 parts by weight of a synthetic resin (solids). Especially for attaining sufficient light proofness and moisture proofness at a coating weight of 25 g/m² or less, the amount of the light proof agent added per 100 parts by weight of the synthetic resin is preferably 15-50 parts by weight. If the amount of the light proof agent per 100 parts by weight of the synthetic resin is less than 3 parts by weight, good light proof performance cannot be obtained. If it exceeds 70 parts by weight, moisture proofness is lowered or light proofness is no more improved. This proportion of the light proof agent has enough light proofness though it is lower than the proportion in previous light proof and moisture proof papers consisting of two layers. The reason for this is unknown, but light proofness was improved probably because the single layer has a greater thickness than conventional individual light proof layers even at the same coating weight as those of two-layer light proof papers (the total coating weight of a light proof layer and a moisture proof layer). Moisture proofness is also sufficient because the absolute amount of the synthetic resin in the light proof and moisture proof layer is increased.

The amount of the wax per 100 parts by weight of the synthetic resin is preferably 1-10 parts by weight (solids). If it is less than 1 part by weight, good moisture proofness is not obtained. If it exceeds 10 parts by weight, the coated layer becomes very fragile so that moisture proofness during folding is considerably lowered. When the amount of the wax is increased, friction coefficient decreases to invite some troubles or rolls of the paper machine tend to be contaminated during recycling as waste paper materials, but these problems are nearly insignificant so far as it is 10 parts by weight or less.

In the present invention, known waxes such as paraffin waxes or polyethylene waxes can be used, among which paraffin waxes are preferred because they are highly water-repellent and well-suited for controlling moisture permeability. It can also be controlled by using a combination of two or more waxes.

The coating weight of the light proof and moisture proof layer on paper is preferably 5-25 g/m² in solids, more preferably 10-20 g/m². If the coating weight is less than 5 g/m², the quality of moisture proofness/light proofness or the like is low. If it exceeds 25 g/m², repulpability is affected and costs for drying facility or the like are increased, which means process disadvantages.

In the present invention, the light proof agent contains 2-50% by weight of graphite, 10-70% by weight of a color pigment and 10-70% by weight of a white pigment as pigment components, which are dispersed in water with a dispersing agent such as water-soluble resins and surfactants, and preferably comprises 40-80% by weight of pigment component, 3-10% by weight of a dispersing agent (in solids) and 10-60% by weight of water. Carbon black should not be used because it is difficult to remove during waste paper recycle process and deteriorates the quality of the recycled paper. When a light proof agent based on pigments in such proportions is used, a paper is obtained which is not only sufficiently light proof but also printable because of the hue of the light proof and moisture proof layer close to that of ordinary kraft paper and which can also be recycled after recovery as waste paper to give a good recycled paper having a hue close to that of kraft paper.

In the hue of the light proof and moisture proof layer of the present invention, the brightness index L* can be controlled by changing the proportions of graphite and color and white pigments contained in the light proof agent or changing the proportions of the light proof agent and synthetic resin. The hue of the light proof and moisture proof layer is preferably close to the hue of ordinary kraft paper and represented by brightness index L* of 25-70 and chromaticity a* of 1-25 and b* of 1-45.

Graphite used in the light proof agent of the present invention is preferably in the form of scales, which show sufficient light proofness. Suitable color pigments include various organic and inorganic pigments used in printing inks and coatings. For example, organic pigments include phthalocyanine pigments, insoluble azo-pigments, azo-lake pigments, anthraquinone pigments, quinacridone pigments, dioxazine pigments, diketopyrrolopyrrole pigments, anthrapyrimidine pigments, anthanthrone pigments, indanthrone pigments, flavanthrone pigments, perinone pigments, perylene pigments, isoindolinone pigments, thioindigo pigments, etc. Inorganic pigments include iron oxide, ultramarine, Prussian blue, cobalt oxide, strontium chromate, titanium yellow, titanium black, zinc chromate, iron black, molybdenum red, molybdenum white, lithopone, emerald green, cadmium yellow, cadmium red, cobalt blue, etc. White pigments include titanium dioxide, zinc white, calcium carbonate, kaolin clay, barium sulfate, etc.

In the present invention, organic pigments having a mean particle diameter of 5-70 μm may be added in order to combine various performances as light proof and moisture proof papers with excellent anti-blocking properties especially important for use as packing papers. If the mean particle diameter is less than 5 μm, sufficient anti-blocking properties may not be obtained because pigments no more sufficiently project over the light proof and moisture proof layer and thus irregularities are reduced. If the mean particle diameter exceeds 70 μm, sufficient anti-blocking properties are attained, but it is not preferred in view of the influence on moisture proof performance because the coated surface tends to be uneven due to scratches or streaks occurring during coating.

The base paper used in the present invention is not specifically limited, but preferably unbleached kraft paper having some light proofness typically used as packing paper, more preferably having a highly smooth compact surface or having a high sizing degree. Preferably, it has a smoothness of 10 seconds or more as measured by Oken testing and a sizing degree of 10 seconds or more as measured by Stöckigt testing. When the base paper has such smoothness and sizing degree, good moisture proofness is obtained because the light proof and moisture proof layer remains on the surface without penetrating into the base paper.

The light proof and moisture proof layer of the present invention can be provided by conventional coating methods using a bar coater, air knife coater, blade coater, roll coater or the like and dried at a temperature that is not specifically limited but preferably at the melting point of the wax emulsion or more.

In the present invention, known materials may be coated for the purpose of anti-slipping or anti-curling on the surface of the base paper opposite to said coated surface.

Light proof and moisture proof papers obtained by the present invention allow improved productivity by conferring moisture proofness and light proofness with a single coated layer unlike the prior art which uses a plurality of coated layers, thereby reducing process constraints such as the number of coating members (coating heads) of the coater or drying equipments and conditions for controlling drying failure such as blister during deposition of the second and subsequent layers. The light proof and moisture proof layer of the present invention ensures desired moisture proofness and light proofness at a coating weight equal to or less than the total coating weight of a moisture proof layer and a light proof layer required to give desired moisture proofness and light proofness in conventional two-layer light proof and moisture proof papers, whereby stock material can be reduced and therefore a substantial cost reduction can be estimated. In addition, papers of the present invention can be readily recycled in existing waste paper recycling equipments to give recycled papers well suitable as packing papers for photosensitive materials or the like, which require light proofness and moisture proofness.

### EXAMPLES

The following examples further illustrate the present invention without, however, limiting the same thereto. Light proof and moisture proof papers prepared in the examples and comparative examples were measured for moisture permeability, light proofness, repulpability and recyclability according to the procedures below and the results are shown in Table 1.

(1) Moisture Permeability

Measured at 40° C., 90% RH with the moisture proof and light proof side facing the high humidity side according to the method of JIS Z 0208 for testing moisture permeability of moisture proof packing papers (the cup method). Commercial utility as moisture proof paper is indicated if the moisture permeability is 55 g/m².24 hr or less, more preferably 45 g/m².24 hr or less.

(2) Light Proofness

Measured with a spectrophotometer (UV-3100PC made by Shimadzu Corporation) and evaluated from the maximum of transmittance for light at 200-800 nm. Commercial utility as light proof paper is indicated if the light transmittance is 2% or less, more preferably 1% or less.

(3) Dissolution Testing of Light Proof Layer at High Humidity

Each sample of light proof and moisture proof paper was inserted between sheets of wood free paper for PPC and kept at 50° C., 90% RH for a week under a load of 50 kg/cm², after which any color change of the wood free paper for PPC was visually evaluated as follows: o: comparable to the color of the initial wood free paper for PPC; x: color changed.

(4) Repulpability

Each sample cut into about 2.5-cm cubes was repulped in tap water at normal temperature at a pulp content of 3% in a standard disintegrator shown in JIS P 8209 relating to the preparation process of handmade papers for pulp testing (Tappi standard disintegrator: 3000 rpm) to evaluate the disintegration time required for obtaining a pulp totally consisting of an assembly of single fibers as follows: ●: disintegrated within 10 minutes (comparable to wood free paper); o: disintegrated within 10-15 minutes; Δ: disintegrated within 15-20 minutes; x: not disintegrated.

(5) Recyclability

The pulp solution after disintegration obtained in the repulpability evaluation above was used to prepare a handmade wet sheet, which was then dried in a KRK rotary dryer (standard type made by Kumagai Riki Kogyo) to visually evaluate contamination of the mirror surface of the cylinder drum by wax as follows: o: no contamination found; Δ: slight contamination found; x: significant contamination found.

### Example 1

A light proof agent was prepared by mixing 10% by weight of graphite (trade name: CX-600 made by Chuetsu Graphite), 30% by weight of red oxide (trade name: EP-40 made by Nippon Bengara Kogyo) as a color pigment, 20% by weight of titanium dioxide (trade name: Tipaque R-930 made by Ishihara Sangyo Kaisha) as a white pigment, 22% by weight of a styrene acrylic resin (trade name: Joncryl 61J made by Johnson Polymer) and 18% by weight of water. Then, a styrene acrylic resin having a gel fraction of 98% in the polymer (trade name: Saibinol X-598-952E-2 made by Saiden Chemical Industry), said light proof agent and a wax (trade name: Saibinol X-591-607E-8 made by Saiden Chemical Industry) were mixed at a solids ratio of 100/30/5 (=styrene acrylic resin/light proof agent/wax) to prepare a coating solution containing 42% solids. The resulting coating solution was applied on a kraft paper having a basis weight of 85 g/m², an Oken smoothness of 20 seconds and a Stöckigt sizing degree of 30 seconds at a coating weight of 16 g/m² (solids) per side with a Meyer bar and then dried at 110° C. for 1 minute with a hot air dryer to prepare a light proof and moisture proof paper having a light proof and moisture proof layer.

### Example 2

A light proof and moisture proof paper was prepared in the same manner as in Example 1 except that the styrene acrylic resin, light proof agent and wax used in Example 1 were mixed at a solids ratio of 100/20/5 (=styrene acrylic resin/light proof agent/wax) to prepare a coating solution.

### Example 3

A light proof and moisture proof paper was prepared in the same manner as in Example 1 except that the styrene acrylic resin, light proof agent and wax used in Example 1 were mixed at a solids ratio of 100/40/5 (=styrene acrylic resin/light proof agent/wax) to prepare a coating solution.

### Example 4

A light proof and moisture proof paper was prepared in the same manner as in Example 1 except that the styrene acrylic resin, light proof agent and wax used in Example 1 were mixed at a solids ratio of 100/30/3 (=styrene acrylic resin/light proof agent/wax) to prepare a coating solution.

### Example 5

A light proof and moisture proof paper was prepared in the same manner as in Example 1 except that the styrene acrylic resin, light proof agent and wax used in Example 1 were mixed at a solids ratio of 100/30/7 (=styrene acrylic resin/light proof agent/wax) to prepare a coating solution.

### Example 6

A light proof and moisture proof paper was prepared in the same manner as in Example 1 except that the styrene acrylic resin used in Example 1 was replaced with a styrene butadiene resin (trade name: SX-1103 made by Nippon Zeon).

### Example 7

A light proof and moisture proof paper was prepared in the quite same manner as in Example 1 except that the styrene acrylic resin, light proof agent and wax used in Example 1 were mixed at a solids ratio of 100/5/5 (=styrene acrylic resin/light proof agent/wax) to prepare a coating solution and the coating weight was 32 g/m².

### Example 8

A light proof and moisture proof paper was prepared in the quite same manner as in Example 1 except that the styrene acrylic resin, light proof agent and wax used in Example 1 were mixed at a solids ratio of 100/60/5 (=styrene acrylic resin/light proof agent/wax) to prepare a coating solution.

### Example 9

A light proof and moisture proof paper was prepared in the quite same manner as in Example 1 except that the styrene acrylic resin used in Example 1 was replaced with a styrene butadiene resin (trade name: SX-1103 made by Nippon Zeon) and the coating weight was 18 g/m² (solids) per side.

### Comparative Example 1

The styrene acrylic resin and light proof agent used in Example 1 were mixed at a solids ratio of 20/100 (=styrene acrylic resin/light proof agent) to prepare a coating solution containing 40% solids for a light proof layer. The resulting coating solution was applied on a kraft paper having a basis weight of 85 g/m², an Oken smoothness of 20 seconds and a Stöckigt sizing degree of 30 seconds at a coating weight of 10 g/m² (solids) per side with a Meyer bar and then dried with a hot air dryer to give a base paper having a light proof layer. Subsequently, the styrene acrylic resin and wax used in Example 1 were mixed at a solids ratio of 100/5 (=styrene acrylic resin/wax) to prepare a coating solution containing 42% solids for a moisture proof layer. The resulting coating solution was applied on the light proof layer of said base paper at a coating weight of 15 g/m² (solids) per side and then dried with a hot air dryer at 110° C. for 1 minute to prepare a light proof and moisture proof paper having a light proof layer and a moisture proof layer.

### Comparative Example 2

A polyvinyl alcohol (trade name: PVA117 made by Kuraray) and a light proof agent were mixed at a solids ratio of 20/100 (=polyvinyl alcohol/light proof agent) to prepare a coating solution containing 40% solids for a light proof layer. The resulting coating solution was applied on a kraft paper having a basis weight of 85 g/m², an Oken smoothness of 20 seconds and a Stöckigt sizing degree of 30 seconds at a coating weight of 10 g/m² (solids) per side with a Meyer bar and then dried with a hot air dryer to give a base paper having a light proof layer. Subsequently, the styrene acrylic resin and wax used in Example 1 were mixed at a solids ratio of 100/5 (=styrene acrylic resin/wax) to prepare a coating solution containing 42% solids for a moisture proof layer. The resulting coating solution was applied on the light proof layer of said base paper at a coating weight of 15 g/m² (solids) per side and then dried with a hot air dryer at 110° C. for 1 minute to prepare a light proof and moisture proof paper having a light proof layer and a moisture proof layer.

### Comparative Example 3

A light proof and moisture proof paper was prepared in the quite same manner as in Example 1 except that the styrene acrylic resin used in Example 1 was replaced with the polyvinyl alcohol used in Comparative example 2.

### Comparative Example 4

A light proof and moisture proof paper was prepared in the quite same manner as in Example 1 except that the styrene acrylic resin, light proof agent and wax used in Example 1 were mixed at a solids ratio of 100/5/5 (=styrene acrylic resin/light proof agent/wax) to prepare a coating solution.

### Comparative Example 5

A light proof and moisture proof paper was prepared in the quite same manner as in Example 1 except that a kraft paper having a basis weight of 85 g/m², an Oken smoothness of 5 seconds and a Stöckigt sizing degree of 5 seconds was used as a base paper.

TABLE 1

| | | | | Disso- | | |
|---|---|---|---|---|---|---|
| | | Moisture | | lution | | |
| | | perme- | Light | of Lp | Re- | Recy- |
| | Coating | ability | transmit- | layer | pulpa- | cla- |
| | weight | (g/m^{2 ·} | tance | at high | bi- | bi- |
| | (g/m²) | 24 hr) | (%) | humidity | lity | lity |
| Ex. 1 | 16 | 40 | 0.6 | o | o | o |
| Ex. 2 | 16 | 36 | 1.5 | o | o | o |
| Ex. 3 | 16 | 44 | 0.3 | o | o | o |
| Ex. 4 | 16 | 45 | 0.6 | o | o | o |
| Ex. 5 | 16 | 35 | 0.6 | o | o | o |
| Ex. 6 | 16 | 45 | 0.6 | o | o | o |
| Ex. 7 | 32 | 10 | 2.0 | o | Δ | o |
| Ex. 8 | 16 | 53 | 0.2 | o | o | o |
| Ex. 9 | 18 | 50 | 0.2 | o | o | o |
| Com. | mp layer 15 | 44 | 1.0 | o | Δ | o |
| ex. 1 | lp layer 10 | | | | | |
| Com. | mp layer 15 | 45 | 1.0 | x | Δ | o |
| ex. 2 | lp layer 10 | | | | | |
| Com. | 16 | 412 | 0.6 | x | o | o |
| ex. 3 | | | | | | |
| Com. | 16 | 28 | 6.0 | o | o | o |
| ex. 4 | | | | | | |
| Com. | 16 | 80 | 0.6 | o | o | o |
| ex. 5 | | | | | | |

mp: moisture proof
lp: light proof

As shown in Table 1, light proof and moisture proof papers of Examples 1-6 all have a moisture permeability of 45 g/m².24 hr or less and a light transmittance of 2.0% or less, demonstrating that they have sufficient moisture proofness and light proofness comparable to those of light proof and moisture proof papers of Comparative examples 1 and 2 consisting of two layers, ie, a light proof layer and a moisture proof layer while the amount of the light proof agent and synthetic resin used can be greatly reduced as compared with Comparative examples 1 and 2. They also have excellent repulpability and recyclability without dissolution of the light proof layer at high humidity. However, the light proof layer dissolved at high humidity in Comparative example 2 using a polyvinyl alcohol in the moisture proof layer and Comparative example 4 using a polyvinyl alcohol in the light proof and moisture proof layer.

As is apparent from a comparison between Example 7 and Comparative example 4, light proof and moisture proof papers having a light proof and moisture proof layer containing less than 15 parts by weight of a light proof agent per 100 parts by weight of a synthetic resin show sufficient light proofness only when the coating weight is increased and repulpability is deteriorated when the coating weight is increased. Moisture proofness is slightly low in Example 8 using a light proof agent in excess of 50 parts by weight per 100 parts by weight of a synthetic resin.

In Comparative example 5 using a base paper having an Oken smoothness of less than 10 seconds and a Stöckigt sizing degree of less than 10 seconds, moisture permeability is low, and the coating weight of the light proof and moisture proof layer must be increased to obtain sufficient moisture permeability, which increases costs and may deteriorate repulpability.

1. A recyclable light proof and moisture proof paper having a single repulpable and recyclable light proof and moisture proof layer on at least one side of a base paper using neither aluminium foil nor an aluminium deposited film.

2. The recyclable light proof and moisture proof paper of claim 1 wherein said light proof and moisture proof layer contains 3-70 parts by weight (solids) of a light proof agent and 1-10 parts by weight (solids) of a wax per 100 parts by weight (solids) of a synthetic resin having a gel fraction of 90% or more.

3. The recyclable light proof and moisture proof paper of claim 1 or 2 wherein said base paper has a Stöckigt sizing degree of 10 seconds or more and an Oken smoothness of 10 seconds or more.

4. The recyclable light proof and moisture proof paper of claim 2 wherein said synthetic resin is selected from the group consisting of styrene acrylic resins and styrene butadiene resins.
